(19) United States
(12) Patent Application Publication
(10) Pub. No.: US 2020/0191664 A1
(43) Pub. Date: Jun. 18, 2020

(54) Spiral-Shaped Broadband Transducer

(71) Applicant: UNIVERSITÁ DEGLI STUDI MAGNA GRAECIA DI CATANZARO, Catanzaro (IT)

(72) Inventors: Antonino Secondo FIORILLO, Reggio Di Calabria (IT); Salvatore Andrea PULLANO, Catanzaro (IT); Costantino Davide CRITELLO, Catanzaro (IT)

(21) Appl. No.: 16/710,072

(22) Filed: Dec. 11, 2019

(30) Foreign Application Priority Data
Dec. 13, 2018 (IT) 102018000011073

(51) Int. Cl. G01L 1/16; G01K 7/00

(52) U.S. Cl. CPC G01L 1/16; G01K 7/003

(57) ABSTRACT

A spiral-shaped broadband transducer made of a piezoelectric/pyroelectric material comprising a spiral-shaped thin film (1) having metalized surfaces electrically connected to two electrodes by means of a conductive connection, a first end (2) having a constraint and a second end (3) having another constraint. The spiral-shaped transducer comprises a plastic component (4, 6) including a first support guide (4a, 6a) and a second support guide (4b, 6b), parallel to each other, being arranged according to a spiral geometry for housing the thin film (1) between the first support guide (4a, 6a) and the second support guide (4b, 6b); a first end of the first support guide (4a, 6a) and of the second support guide (4b, 6b) being clamped to a first vertical element (21a, 7, 8) having a first vertical slit (5′, 10) for housing the first end (2) of the spiral-shaped thin film (1); a second end of the first support guide (4a, 6a) and of the second support guide (4b, 6b) being fixed to a second clamping vertical element (21b, 21c) having a second vertical slit (5, 5″) for housing the second end (3) of the spiral-shaped thin film (1).

### CROSS-REFERENCE TO RELATED APPLICATION

This application claims the benefit and priority of Italian Patent Application No. 102018000011073, filed Dec. 13, 2018. The entire disclosure of the above application is incorporated herein by reference.

### FIELD

The present invention relates to a spiral-shaped broadband transducer.

### BACKGROUND

The present invention relates to a spiral-shaped transducer in the field of piezoelectric and pyroelectric transducers made of a spiral-shaped thin film to realize echolocating devices suitable for robotic systems and for implantable devices to stimulate the cerebral cortex. For example, these systems are used to evaluate the Time-of-Flight, in indoor and outdoor positioning systems, or to evaluate biomedical parameters used for example in the rehabilitation of visually impaired people or for electrical brain stimulation in the scenario of the implantable devices.

It is well known that the piezoelectric transducers are able to convert a mechanical deformation in an electric signal, or a potential difference in mechanical deformation, based on its direct or converse use.

Moreover, the pyroelectric transducers are devices able to produce a variation of the electric polarization due to temperature changes, caused, for example, by adsorption of thermal radiation. Different types of materials are known for the fabrication of piezoelectric and pyroelectric transducers: polyvinylidene fluoride (PVDF) or polyvinyl difluoride (PVF2), polyvinylidene fluoride trifluoroethylene (PVDF-TrFE), Polyvinyl difluoride chlorine trifluoroethylene, SU-8/ZnO nanocomposite, composite of polydimethylsiloxane and carbon nanotubes and barium titanate (BaTiO₃) nanoparticles, aluminum nitride, composite of lead niobate and magnesium/lead titanate (PMN/PT)/epoxy resyn, polyamide, lead zirconate titanate (PZT) and its composites. These transducers comprise planar and non-planar films, preferably thin films, metalized on both sides, and ad hoc poled.

Cylindric and hemi-cylindric shaped transducers are well known. In these transducers, the film is folded to obtain a cylindric or hemi-cylindric geometry, in which the polarization direction is orthogonal in each point of the larger surface of the film. Single or multiple transducers, based on the above mentioned geometries were analytically and experimentally described by: “Fiorillo A. S.” (IEEE Trans. On Ultrasonics, Ferroelectrics, and Frequency Control 1992, 44(6), 688-692), “Brown L. F.” (IEEE Trans. On Ultrasonics, Ferroelectrics, and Frequency Control 2000, 47(6), 1377-1396), “Toda M.” (IEEE Trans. On Ultrasonics, Ferroelectrics, and Frequency Control 2002, 49(5), 626-634. Particularly, in the hemi-cylindric transducer the ends of the film are rigidly clamped and the application of an electric field, for example in alternated current, between the two metalized surfaces, determines that the displacement in longitudinal direction, in the film without clamps, is converted into radial direction in the hemi-cylindric geometry, resulting in emission of acoustic radiation. In particular, ultrasonic waves are generated in fluid medium, preferably air. Instead, a mechanical wave at ultrasonic frequencies, impinging on the thin film, generates a potential difference between the surfaces. If this film is poled in a direction perpendicular to the cylinder axis, this ultrasonic resonator has the characteristic that the resonance frequency is inversely proportional to the bending radius of the cylinder (not considering a constant scaling factor that comprises S^{E}₁₁ and ρ, tangential compliance and mean density of the metallized film, respectively). However, such a transducer has a narrow frequency band, lower than 10 kHz.

In addition, commercially available cylindrical shaped PVDF transducers manufactured by Measurement Specialties, having resonance frequency of 40 kHz or 80 kHz, are characterized by a limited frequency band, lower than 10 kHz. Moreover, these transducers are characterized by omnidirectional properties of the acoustic field in the horizontal plane only. Moreover, transducers made of thin film folded according to a hemi-conical geometry are well known, having a frequency band lower than 10 kHz between 25 kHz and 35 kHz. All the described transducers are limited by a narrow frequency band, lower than 10 kHz.

### SUMMARY

Scope of the present invention is to provide a spiral-shaped broadband transducer having a band preferably greater than 10 kHz, more preferably greater than 20 kHz, even more preferably greater than 40 kHz, namely having characteristics overcoming the frequency limitations of the known transducers.

According to the present invention, a spiral-shaped broadband transducer is realized, as defined in the claim 1.

### DRAWINGS

For a better understanding of the present invention, a preferred embodiment is described, as a pure non-limitative example, with reference to the enclosed drawings, in which:

FIG. 1 shows an enlarged cross-section of a spiral-shaped transducer comprising a thin film having two rigidly constrained ends, according to the invention;

FIG. 2 shows a perspective view of the thin film arranged in a spiral-shaped geometry, according to the invention;

FIG. 3 shows a rigid support of a first embodiment of the spiral shaped broadband transducer, according to the invention;

FIG. 4 shows a rigid support of a second embodiment of the spiral shaped broadband transducer, according to the invention;

FIG. 5 shows a detailed perspective view of a clamping element, according to the invention;

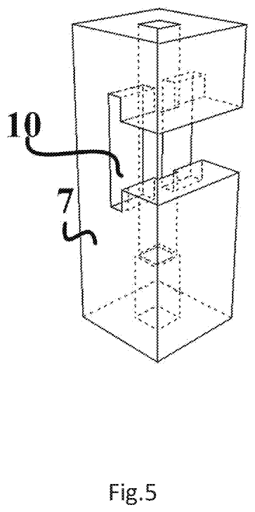

FIG. 6 shows a perspective view of a metallic pin for the realization of the electrical contact with one of the metalized surfaces of the spiral-shaped thin film, according to the invention;

FIG. 7 shows a block diagram of a conditioning circuit used for driving the spiral-shaped broadband transducer, according to the invention;

FIG. 8 shows a block diagram of a conditioning circuit used to receive ultrasonic signals by means of spiral-shaped broadband transducers, according to the invention.

### DETAILED DESCRIPTION

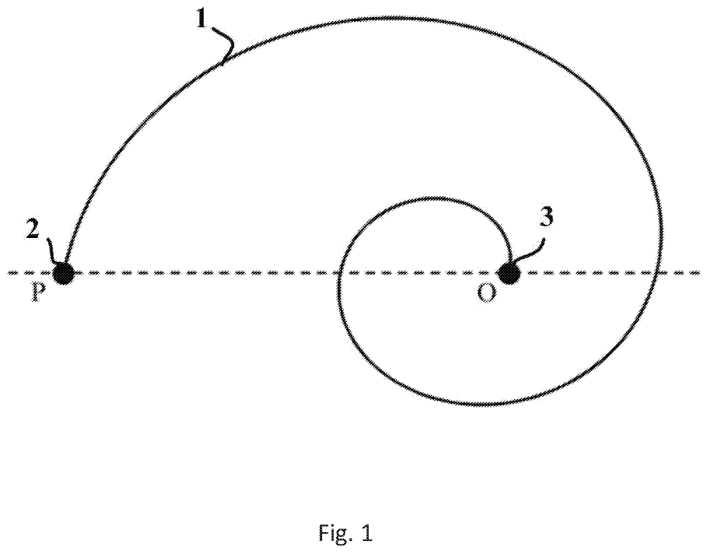

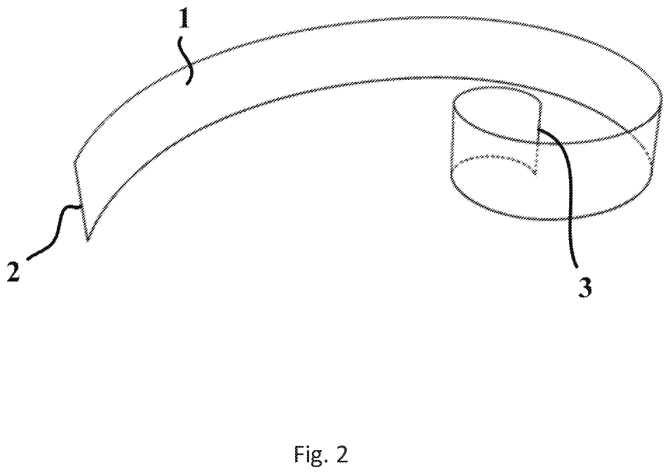

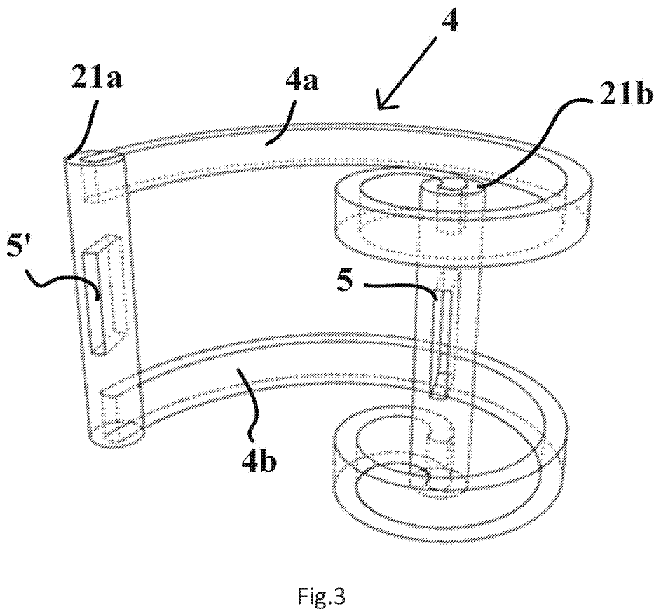

With particular regards to the FIGS. 1-4, the components of a spiral-shaped broadband transducer are shown, according to the invention. In particular, a first embodiment of the spiral-shaped broadband transducer comprises a thin film 1 folded according to a Fibonacci spiral or logarithmic spiral or Archimede spiral, as shown in FIGS. 1 and 2, clamped at the first end 2 and a second end 3, and a thickness preferably comprised between 9 μm and 110 μm, more preferably comprised between 28 μm and 52 μm, even more preferably comprised between 28 μm and 40 μm.

According to the invention, the thin film 1 is made of a piezoelectric or pyroelectric material and its surfaces are both metalized with Aluminum or other conductive materials, at least one or a plurality of layers. Moreover, according to an aspect of the invention, the thin film 1 is fixed by means of conductive connection (not shown) to two copper electrodes or equivalent materials electrodes. The electric connection between the electrode and both metalized surfaces of the thin film is obtained by silver loaded epoxy resin.

According to an aspect of the invention, the spiral-shaped broadband transducer comprises a support of the thin film 1, comprising a component 4 preferably made of thermoplastic polymer Acrylonitrile-styrene-butadiene (ABS) or polylactic acid (PLA). The ends 2 and 3 are clamped to the support element 4 so that a spiral geometry is realized (for instance a Fibonacci spiral, or a logarithmic spiral, or an Archimede spiral or an equivalent spiral). In more detail, the support element 4 comprises a first support-guide 4a and a second support-guide 4b parallel each other, having a spiral-shaped arrangement to hollow the thin film 1 guided between the first support-guide 4a and the second support-guide 4b. A first end of the first support guide 4a and a first end of the second support guide 4b are fixed to a first clamping element 21a having a first vertical slit 5′ to hollow the end 2 of the thin film 1; a second end of the first support guide 4a and the second end of the support guide 4b are fixed to a second clamping element 21b having a second vertical slit 5 to hollow the end 3 of the thin film 1. The ends 2 and 3 of the thin film 1 are fixed using epoxy resin to the clamping elements 21a and 21b.

According to an aspect of the invention, the thin film 1 has a variable length, which depends on the desired frequency band. As an example, for frequencies comprised between 20 kHz and 100 kHz the length of the thin film 1 is preferably equal to 5 cm. The height of the thin film 1 depends on the desired sensitivity and shape of radiation lobe; as an example, for a film having a height preferably equal to 3 mm signals can be received in air from a planar reflector located at a distance up to 30 cm. Changing the bending radius of the thin film 1 of the transducer, a plurality of resonant and non-resonant vibrations within ultrasonic frequencies range (from hundreds of kHz to some MHz) can be excited for transmitting and/or receiving acoustic signals.

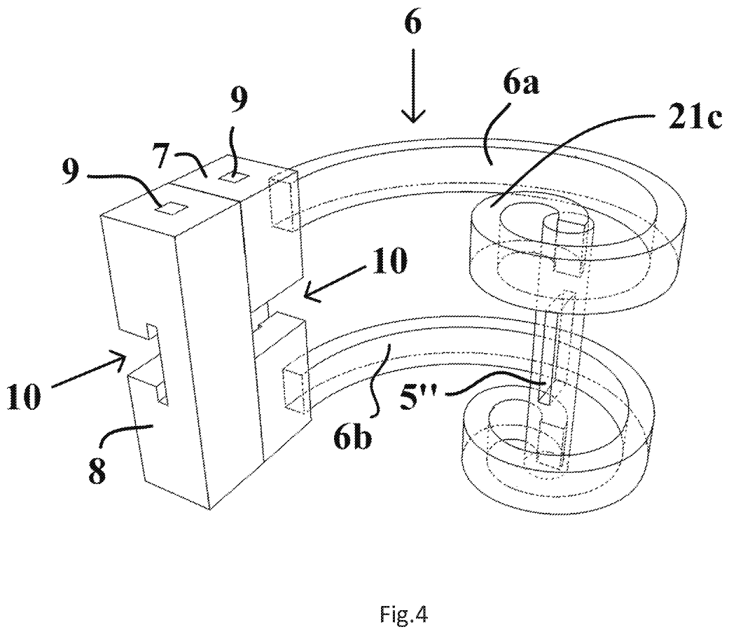

According to another aspect of the invention, FIG. 4 shows a second embodiment of the spiral-shaped broadband transducer comprising another component 6 comprising a first support-guide 6a and a second support guide 6b parallel to each other, each of them being shaped as spiral to hollow one of the spiral film 1 guided between the first support guide 6a and the second support guide 6b. First ends of the first support guide 6a and the second support guide 6b are fixed to a first vertical clamping element 7 and a second vertical clamping element 8 adjacent to the first vertical clamping element 7 and forming with it a slit 10, for example shaped as a “C” or an “Ω”, configured to hollow the end 2 of the thin film 1. Second ends of the first support guide 6a and of the second support guide 6b are fixed to another vertical clamping element 21c having a vertical seat 5″ configured to hollow the end 3 of the thin film 1. The ends 2 and 3 are fixed inside the slit 10, which is shaped, as a pure non-limitative example, with a “C” or “Ω” shaped structure.

The thin film 1 is electrically connected to two electrodes, not shown in the figures, by means of a conductive cable. The electrical connection is obtained by silver loaded epoxy resin.

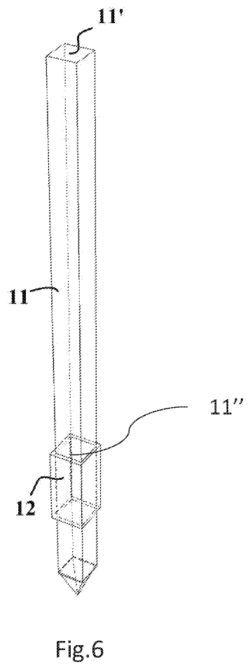

According to an aspect of the invention, the first clamping element 7 and the second clamping element 8 are each provided with pass-through hole 9 configured for housing metal pins 11, shown in FIG. 6, acting as electrodes for the electric contact with the thin film 1. The metal pin 11 has preferably a planar end 11′ and a sharpened opposite end 11″.

According to another aspect of the invention, the section of the pin 11 is squared, or rectangular, or circular or ellipsoidal, and is identical to the section of the pass-through holes 9.

The pin 11 is provided with a thickening 12 configured for the blocking of the pin 11 inside respectively the clamping elements 7 and 8.

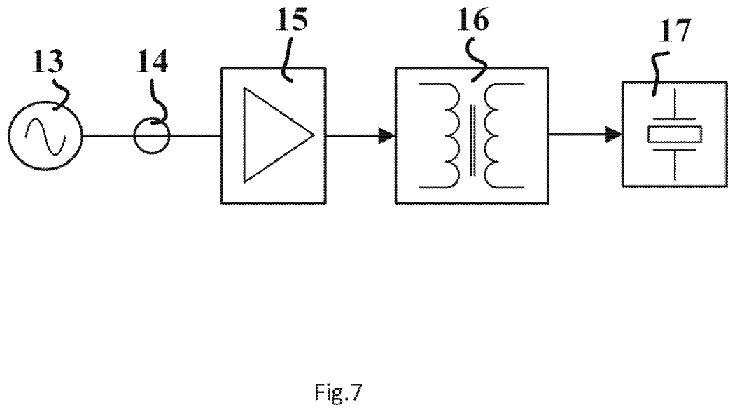

FIG. 7 shows a circuit to drive the transducer in the desired range of frequencies, preferably between 20 kHz and 100 kHz. The circuit comprises a signal generator 13, preferably sinusoidal generator or a pulse generator, a coaxial cable 14, an amplifier stage 15, and a voltage step-up stage 16, determining the vibration of the transducer 17.

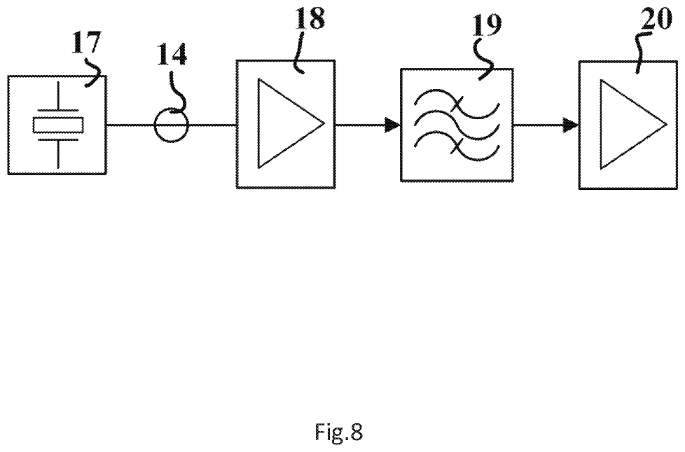

The circuit in FIG. 8 illustrates the conditioning circuit for the echo signal received by the transducer in the desired range of frequencies, preferably between 20 kHz and 100 kHz. The circuit comprises a low noise amplifier stage 18 connected to the transducer 17 by means of a coaxial cable 14. The circuit comprises also a bandpass filter stage 19 and a final amplifier stage 20. In a different embodiment, the electronic circuit can be integrated and mounted on the plastic support.

A device comprising a plurality of transducers according to the invention can be used both as receiver and transmitter.

The transducer, according to the invention, represents a summation of contiguous hemi-cylindrical resonators having different bending radii and arc lengths so that each component of the summation is inversely proportional to the spiral bending radius. Each portion of the thin film of the transducer is curved according to a defined bending radius, and thus preferably subjected to a specific resonant vibration or more preferably to a plurality of resonant vibrations. There is a plurality of hemi-cylindrical geometries distributed for all the length L of the spiral-shaped thin film.

When a potential difference is applied between the two metalized surfaces of the clamped spiral-shaped geometry, whose ends are rigidly constrained to two parallel lines tangential to the spiral, due to the converse piezoelectric effect, a plurality of vibrating modes (such as flexural and extensional modes) are determined.

Therefore, the spiral-shaped thin film transducer, according to the invention, can efficiently transmit and receive ultrasonic waves in a broad frequency range, which is a function of the size of the thin film. The vibrating frequencies are preferably greater than 10 kHz, more preferably greater than 20 kHz, and even more preferably greater than 40 kHz.

Advantageously, according to the proposed geometry, the transducer possesses transmitting and receiving omnidirectional characteristics, in both horizontal and vertical planes.

According to an aspect of the invention, the length of the thin film is comprised between 5 cm and 10 cm obtaining low and medium ultrasonic frequencies, depending on the desired application.

In other applications, as an example in fluid medium, preferably liquid medium, the transducer is electrically insulated by deposition of thin layer of insulating and water repellent polymer, such as polysiloxanes, having a thickness preferably comprised between 500 μm and 1 mm, more preferably between 100 μm and 500 μm, even more preferably comprised between 1 μm and 100 μm.

The electronic conditioning circuit for transmission and reception of the signals of the transducer can be analogic or digital.

One or more transducers according to the invention can be used to detect the shape of an infrared radiation beam. To do that, it's necessary to position the surface of the film of the transducer orthogonally with respect to the radiation beam; alternately expose and not expose the thin film to the incident radiation using a controlled radiation beam or a shutter device; detect the pyroelectric signal generated by the variation of the electrical polarization caused by thermal variation between the surfaces of the transducer using an electronic acquiring signal, such as a charge amplifier; analyze in direct mode the intensity of the incident beam using the maximum value of the pyroelectric response to evaluate the energy of the laser pulse by means of a charge amplifier; determine the temperature variations of the sheet.

According to an aspect of the invention, the transducer can evaluate parameters of biomedical interest, useful for evaluation and rehabilitation of visually impaired subjects in systems such as sensorized white cane, or for electrical brain stimulation in the scenario of the implantable devices. Thus, the spiral-shaped broadband transducer, according to the invention, can allow to transmit and/or receive a wide range of ultrasonic frequencies.

Moreover, the spiral-shaped transducer, according to the invention, can be used in all directions and in both horizontal and vertical planes.

It's clear that the spiral-shaped broadband transducer, according to the invention here described and illustrated, can be subject to changes and modifications without going out from the field of the invention, as defined in the attached claims.

1. A spiral-shaped broadband transducer made of a piezoelectric/pyroelectric material comprising:
a spiral-shaped thin film (1) having metalized surfaces electrically connected to two electrodes by means of a conductive connection, a first end (2) having a constraint and a second end (3) having another constraint;
wherein the spiral-shaped transducer comprises a plastic component (4, 6) including a first support guide (4a, 6a) and a second support guide (4b, 6b), parallel to each other, being arranged according to a spiral geometry for housing the thin film (1) between the first support guide (4a, 6a) and the second support guide (4b, 6b);
a first end of the first support guide (4a, 6a) and of the second support guide (4b, 6b) being clamped to a first vertical element (21a, 7, 8) having a first vertical slit (5′, 10) for housing the first end (2) of the spiral-shaped thin film (1);
a second end of the first support guide (4a, 6a) and of the second support guide (4b, 6b) being fixed to a second clamping vertical element (21b, 21c) having a second vertical slit (5, 5″) for housing the second end (3) of the spiral-shaped thin film (1).

2. The spiral-shaped broadband transducer according to claim 1, wherein the first vertical element (21a) and the second vertical element (21b) have a circular or a rectangular section.

3. The spiral-shaped broadband transducer according to claim 1, wherein the first vertical clamping element (7, 8) comprises a first clamping vertical element (7) and a second clamping vertical element (8) adjacent to the first clamping vertical element (7).

4. The spiral-shaped broadband transducer according to claim 1, wherein the slit (10) has a non-limitative “C” or “Ω” shaped structure.

5. The spiral-shaped broadband transducer according to claim 1, wherein the first clamping vertical element (7) and the second clamping vertical element (8) are provided with a pass-through hole (9) for housing a metal pin (11) acting as electrodes for the electric contact with the spiral-shaped thin film (1).

6. The spiral-shaped broadband transducer according to claim 5, wherein the metal pin (11) has a first planar end (11′) and a second sharpened opposite end (11′).

7. The spiral-shaped broadband transducer according to claim 6, wherein the metal pin (11) is provided with a thickening (12) for the blocking of the pin (11) inside the adjacent vertical clamping elements (7, 8).

8. A transmitter device comprising at least one spiral-shaped transducer according to claim 1.

9. A receiver device comprising at least one spiral-shaped transducer according to claim 1.
